(19) United States
(12) Patent Application Publication
(10) Pub. No.: US 2008/0291448 A1
(43) Pub. Date: Nov. 27, 2008

(54) METHODS AND APPARATUS FOR FINDING A SUBSTRATE NOTCH CENTER

(75) Inventors: Hui Chen, Burlingame, CA (US); Noel Manto, Walnut Creek, CA (US); Haochuan Zhang, Sunnyvale, CA (US); Alpay Yilmaz, San Jose, CA (US)

Correspondence Address: DUGAN & DUGAN, PC, 245 Saw Mill River Road, Suite 309, Hawthorne, NY, 10532, US

(73) Assignee: APPLIED MATERIALS, INC., Santa Clara, CA (US)

(21) Appl. No.: 12/124,135

(22) Filed: May 20, 2008

Related U.S. Application Data
(60) Provisional application No. 60/939,353, filed on May 21, 2007.

(51) Int. Cl. G01B 11/00

(52) U.S. Cl. 356/400

(57) ABSTRACT

Methods and apparatus are provided for locating a notch and/or a center of the notch of a substrate. An exemplary method includes rotating a substrate; illuminating an edge of the substrate with a light beam as the substrate rotates; detecting a change in light intensity of the light beam as the substrate rotates; determining a rough location of a notch in the edge of the substrate based on a position of the substrate when the change in light intensity of the light beam is detected; and reversing a rotational direction of the substrate to determine a fine location of the notch in the edge of the substrate. Numerous other aspects are provided.

The present application claims priority from U.S. Provisional Patent Application Ser. No. 60/939,353, filed May 21, 2007, entitled “METHODS AND APPARATUS FOR FINDING A SUBSTRATE NOTCH CENTER” (Attorney Docket No. 11244/L), which is hereby incorporated by reference herein in its entirety.

### CROSS-REFERENCE TO RELATED APPLICATIONS

The present application is related to the following commonly-assigned, co-pending U.S. Patent Applications, each of which is hereby incorporated herein by reference in its entirety for all purposes:

U.S. patent application Ser. No. 11/299,295 filed on Dec. 9, 2005 and entitled “METHODS AND APPARATUS FOR PROCESSING A SUBSTRATE” (Attorney Docket No. 10121);

U.S. patent application Ser. No. 11/298,555 filed on Dec. 9, 2005 and entitled “METHODS AND APPARATUS FOR PROCESSING A SUBSTRATE” (Attorney Docket No. 10414);

U.S. patent application Ser. No. 11/693,695 filed on Mar. 29, 2007 and entitled “METHODS AND APPARATUS FOR POLISHING AN EDGE OF A SUBSTRATE” (Attorney Docket No. 10560);

U.S. Patent Application Ser. No. 60/939,351, filed May 21, 2007, entitled “METHODS AND APPARATUS FOR POLISHING A NOTCH OF A SUBSTRATE USING AN INFLATABLE POLISHING WHEEL” (Attorney Docket No. 10674/L);

U.S. Patent Application Ser. No. 60/939,343, filed May 21, 2007, entitled “METHODS AND APPARATUS TO CONTROL SUBSTRATE BEVEL AND EDGE POLISHING PROFILES OF EPITAXIAL FILMS” (Attorney Docket No. 11417/L);

U.S. Patent Application Ser. No. 60/939,219, filed May 21, 2007, entitled “METHODS AND APPARATUS FOR POLISHING A NOTCH OF A SUBSTRATE USING A SHAPED BACKING PAD” (Attorney Docket No. 11483/L);

U.S. Patent Application Ser. No. 60/939,342, filed May 21, 2007, entitled “METHODS AND APPARATUS FOR REMOVAL OF FILMS AND FLAKES FROM THE EDGE OF BOTH SIDES OF A SUBSTRATE USING BACKING PADS” (Attorney Docket No. 11564/L);

U.S. Patent Application Ser. No. 60/939,350, filed May 21, 2007, entitled “METHODS AND APPARATUS FOR USING A BEVEL POLISHING HEAD WITH AN EFFICIENT TAPE ROUTING ARRANGEMENT” (Attorney Docket No. 11565/L);

U.S. Patent Application Ser. No. 60/939,344, filed May 21, 2007, entitled “METHODS AND APPARATUS FOR USING A ROLLING BACKING PAD FOR SUBSTRATE POLISHING” (Attorney Docket No. 11566/L);

U.S. Patent Application Ser. No. 60/939,333, filed May 21, 2007, entitled “METHODS AND APPARATUS FOR SUBSTRATE EDGE POLISHING USING A POLISHING ARM” (Attorney Docket No. 11567/L);

U.S. Patent Application Ser. No. 60/939,212, filed May 21, 2007, entitled “METHODS AND APPARATUS FOR IDENTIFYING A SUBSTRATE EDGE PROFILE AND ADJUSTING THE PROCESSING OF THE SUBSTRATE ACCORDING TO THE IDENTIFIED EDGE PROFILE” (Attorney Docket No. 11695/L);

U.S. Patent Application Ser. No. 60/939,337, filed May 21, 2007, entitled “METHODS AND APPARATUS FOR HIGH PERFORMANCE SUBSTRATE BEVEL AND EDGE POLISHING IN SEMICONDUCTOR MANUFACTURE” (Attorney Docket No. 11809/L);

U.S. Patent Application Ser. No. 60/939,209, filed May 21, 2007, entitled “METHODS AND APPARATUS FOR POLISHING A NOTCH OF A SUBSTRATE BY SUBSTRATE VIBRATION” (Attorney Docket No. 11952/L); and

U.S. Patent Application Ser. No. 60/939,209, filed May 21, 2007, entitled “METHODS AND APPARATUS FOR CONTROLLING THE SIZE OF AN EDGE EXCLUSION ZONE OF A SUBSTRATE” (Attorney Docket No. 11987/L).

### FIELD OF THE INVENTION

The present invention relates generally to substrate processing, and more particularly to methods and apparatus for finding the center of a notch in a substrate to aide in substrate edge and bevel cleaning.

### BACKGROUND OF THE INVENTION

Substrates are used in electronic device manufacturing. Often times a substrate includes a notch for alignment. The notch may be used to align the substrate in various processes. Conventional notch locator systems may be sensitive to variations in substrate size, notch size and substrate eccentricities. Accordingly, improved methods and apparatus for locating a center of a notch of a substrate are desired.

### SUMMARY OF THE INVENTION

In aspects of the invention, a method for locating the center of a notch in a substrate is provided. The method includes rotating a substrate; illuminating an edge of the substrate with a light beam as the substrate rotates; detecting a change in light intensity of the light beam as the substrate rotates; determining a rough location of a notch in the edge of the substrate based on a position of the substrate when the change in light intensity of the light beam is detected; and reversing a rotational direction of the substrate to determine a fine location of the notch in the edge of the substrate.

In other aspects of the invention, an apparatus for detecting a notch in an edge of a substrate is provided. The apparatus includes a substrate support adapted to support and rotate a substrate; a light source adapted to emit a light beam at an edge of the substrate as the substrate is rotated by the substrate support; a sensor adapted to detect a change in light intensity of the light beam as the substrate rotates; and at least one controller adapted to (a) determine a rough location of a notch in the edge of the substrate based on a position of the substrate when the change in light intensity of the light beam is detected by the sensor; and (b) reverse a rotational direction of the substrate to determine a fine location of the notch in the edge of the substrate. Numerous other aspects are provided.

Other features and aspects of the present invention will become more fully apparent from the following detailed description, the appended claims and the accompanying drawings.

### BRIEF DESCRIPTION OF THE FIGURES

FIG. 1 is a schematic illustration of a cross-section of a portion of a substrate.

FIG. 2 is a schematic illustration of an edge and bevel polishing system in accordance with the present invention.

FIG. 3 is a close-up schematic illustration of a notch.

FIG. 4 is a schematic illustration of a first exemplary notch center locator apparatus according to the present invention.

FIG. 5 is a schematic illustration of a second exemplary notch center locator apparatus according to the present invention.

FIG. 6 is a flow chart depicting a first exemplary method for finding the center of a notch according to the present invention.

FIG. 7 is a flow chart depicting a second exemplary method for finding the center of a notch according to the present invention.

### DETAILED DESCRIPTION

The present invention provides improved methods and apparatus for locating the center of a notch in an edge of a substrate. As described above, the substrate notch may be used to align the substrate for different processes. According to the present invention, the substrate may be supported and rotated by a driver, as a light source shines a light beam at the edge of the substrate. The present invention may also include a sensor positioned to detect the light beam emitted from the light source. In some embodiments, as the substrate rotates, the light beam is substantially blocked from the sensor by the edge of the substrate, except when the notch of the substrate intercepts the path of the light beam. When the substrate's rotational position is such that the notch is in the light beam's path, more of the light beam is able to pass through the notch and contact the sensor. The sensor may then transmit a signal indicative of the detection of a first (and/or second) edge of the notch, as well a rough location of a notch center. The driver which rotates the substrate may then reverse the rotation of the substrate to more accurately detect the location of the first edge of the notch, via the sensor. For example, the substrate may be rotated back past the location at which the change in light intensity was observed, reverse direction and again pass the notch at a slower speed to more accurately detect the first edge of the notch. The second edge of the notch may be found in a similar manner. After the positions of the first and second edges of the notch are determined, a controller may apply an algorithm to this data to determine a fine location of the notch center. In some embodiments, the driver may then be commanded to rotate the substrate such that the substrate is aligned with respect to the notch center.

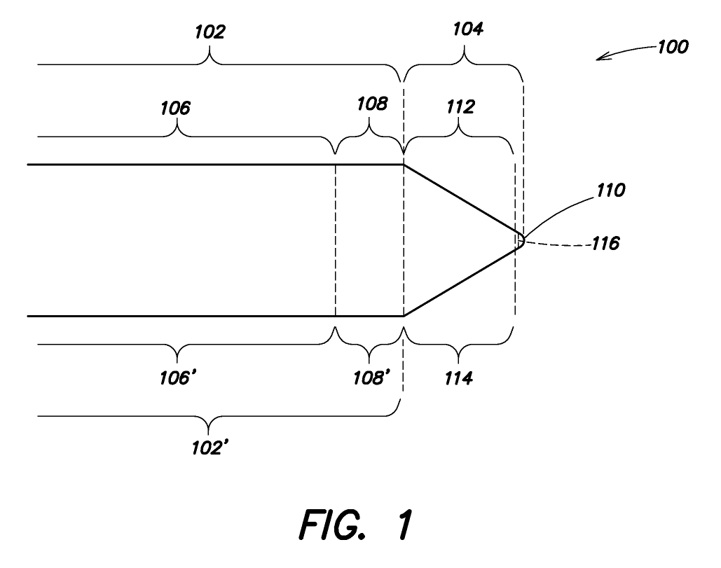

The present invention also provides improved methods and apparatus for cleaning and/or polishing the edge of a substrate. With reference to FIG. 1, a substrate 100 may include two major surfaces 102, 102′ and an edge 104. Each major surface 102, 102′ of the substrate 100 may include a device region 106, 106′ and an exclusion region 108, 108′. (Typically however, only one of the two major surfaces 102, 102′ will include a device region and an exclusion region.) The exclusion regions 108, 108′ may serve as buffers between the device regions 106, 106′ and the edge 104. The edge 104 of a substrate 100 may include an outer edge 110 and bevels 112, 114. The bevels 112, 114 may be located between the outer edge 110 and the exclusion regions 108, 108′ of the two major surfaces 102, 102′. A notch 116 may be located in the outer edge 110 of the substrate 100 and be used to align/position the substrate 100 during various processing steps (e.g., lithography, deposition, etching, cleaning, etc.). The present invention is adapted to locate the center of the notch 116.

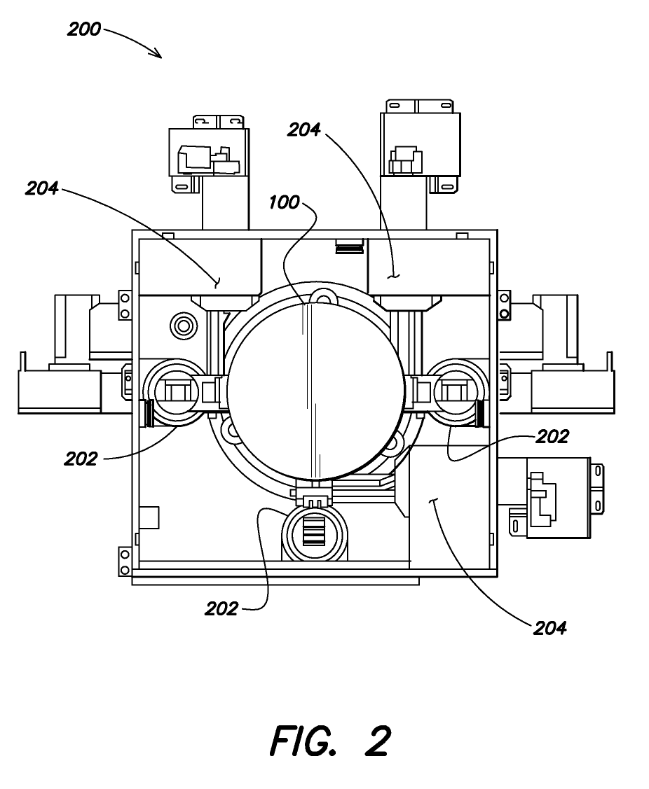

Turning to FIG. 2, a perspective view of an exemplary embodiment of an edge cleaning system 200 is depicted. FIG. 2 depicts an edge polishing system 200 including three heads 202, each attached to a polishing apparatus 204. However, any number and type of heads 202 may be used in any practicable combination. In addition, in such multi-head embodiments, each head 202 may use a differently configured or type of a polishing tape (e.g., different grits, materials, tensions, pressures, etc.) to contact and polish the edge 104 of the substrate 100. Any number of heads 202 may be used concurrently, individually, and/or in any sequence. The heads 202 may be disposed in different positions and in different orientations (e.g., aligned with the substrate edge 104, normal to the substrate edge 104, angled relative to the substrate edge 104, etc.) to allow polishing tape, pushed by a pad in some embodiments (not shown), to polish different portions of the edge 104 of the substrate 100.

In some embodiments, one or more of the heads 202 may be adapted to be oscillated or moved (e.g., be angularly translated about a tangential axis of the substrate 100 and/or circumferentially relative to the substrate 100) around or along the substrate edge 104 so as to polish different portions of the substrate edge 104. Different heads 202 may be used for different substrates 100 or different types of substrates 100.

Substrate polishing may be performed using one or more polishing apparatuses 204. In one or more embodiments, a plurality of polishing apparatuses 204 may be employed, in which each polishing apparatus 204 may have similar or different characteristics and/or mechanisms. In the latter case, particular polishing apparatuses 204 may be employed for specific operations. For example, one or more of a plurality of polishing apparatuses 204 may be adapted to perform relatively rough polishing and/or adjustments while another one or more of the plurality of polishing apparatus 204 may be adapted to perform relatively fine polishing and/or adjustments. Polishing apparatuses 204 may be used in sequence so that, for example, a rough polishing procedure may be performed initially and a fine polishing procedure may be employed subsequently to make adjustments to a relatively rough polish as needed or according to a polishing recipe. The plurality of polishing apparatuses 204 may be located in a single chamber or module, as shown herein, or alternatively, one or more polishing apparatuses 204 may be located in separate chambers or modules. Where multiple chambers are employed, a robot or another type of transfer mechanism may be employed to move substrates 100 between the chambers so that polishing apparatuses 204 in the separate chambers may be used in series or otherwise.

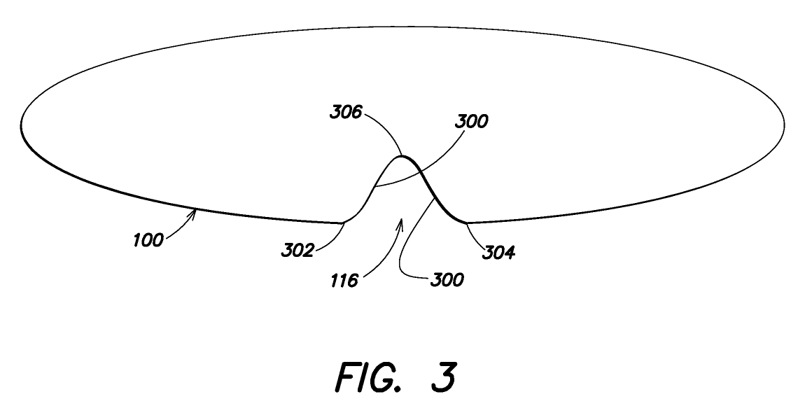

Turning to FIG. 3, an exemplary perspective illustration of the substrate 100, including the substrate notch 116 is provided. The size of the notch 116 is exaggerated for clarity purposes. The notch 116 may include one or more notch sides 300. The notch 116 may also include a first notch corner or node 302 and a second notch corner or node 304. Each notch corner 302, 304 may be positioned at the intersection of a notch side 300 and the outer perimeter of the substrate 100. The notch 116 may further include a notch center 306, positioned at the intersection of the notch sides 300. The notch center 306 may be used to align the substrate 100 during processing.

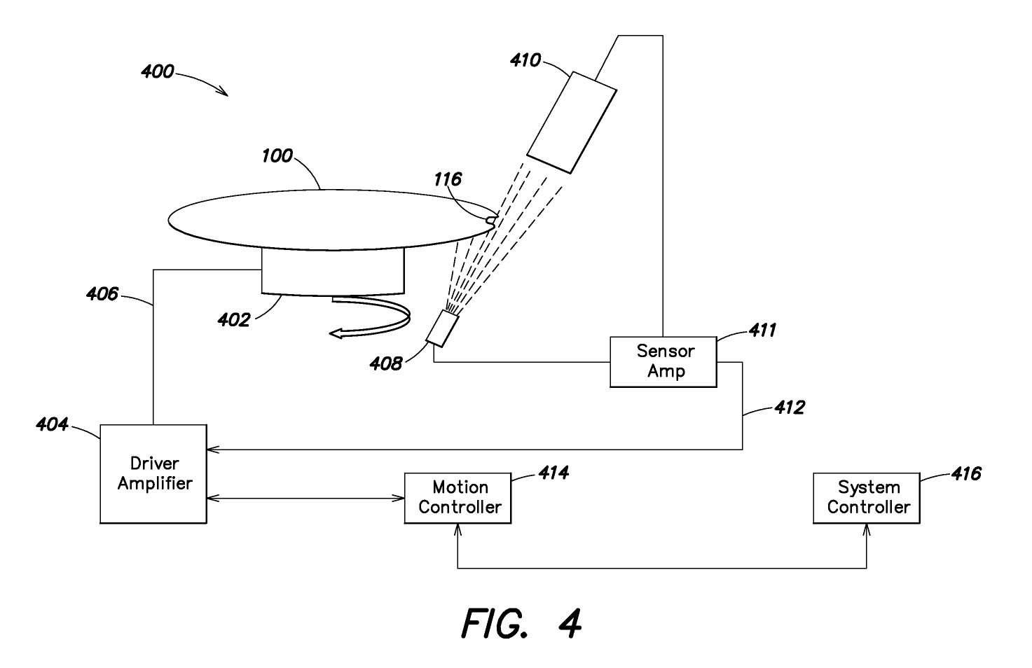

Turning to FIG. 4, an exemplary apparatus 400 for finding the notch center 306 in the substrate edge 104 is provided according to the present invention. The substrate 100 may be held or supported, and rotated (as indicated by the directional arrow) by a vacuum chuck, for example, coupled to a driver 402 (e.g., motor, gear, belt, chain, etc.). Other means may be used to rotate the substrate 100, for example, driver rollers, guide rollers, etc. However, by holding the substrate by a vacuum chuck, high-speed rotation without significant vibration may be achieved. Additional advantages of using a vacuum chuck instead of rollers include the elimination of the need to clean rollers as well as the elimination of the possibility of rollers damaging or scratching the edge of the substrate.

The apparatus 400 may further include a driver or motor amplifier 404, which may be coupled to the driver 402. The driver 402 may send an encoder signal 406, for example, to the driver amplifier 404 indicative of the position of the driver 402. As the substrate 100 may be stationary on the driver 402, the position of the driver 402 may also be indicative of the position of the substrate 100.

A light source 408 may be adapted to transmit a light beam at the substrate edge 104. One or more light sensors 410 may sense the intensity of the light beam received from the light source 408 as the light beam passes the substrate edge 104, and send an intensity signal 412 indicating the sensed intensity to the driver amplifier 404. In some embodiments, the intensity signal 412 may be routed through an amplifier 411 to enhance the signal. As the substrate edge 104 passes through the light beam emitted by the light source 408, the light sensor 410 may sense a fairly constant light intensity and may send the intensity signal 412 indicating this intensity to the driver amplifier 404. However, when the substrate notch 116 passes through the light beam emitted by the light source 408, the intensity of the illumination detected by the light sensor 410 may increase because the notch 116 blocks less of the light beam, thereby allowing a greater intensity of light to pass to the light sensor 410. The one or more light sensors 410 may receive the higher light intensity, and may transmit this information as the intensity signal 412 to the driver amplifier 404.

In some embodiments, the one or more light sensors 410 may be digital, and include an adjustable threshold. For example, a light sensor 410 may only generate an intensity signal when the sensor detects light intensity or a change in light intensity that exceeds the adjustable threshold. Other sensors with or without adjustable thresholds may be used. The intensity signal 412 transmitted by the sensor 410 may also be filtered for noise (i.e., ambient light).

As indicated above, the driver amplifier 404 may keep track of the position of the substrate 100, via the encoder signal 406, and the notch detection via the intensity signal 412. The information from the encoder and intensity signals 406, 412, respectively, may be transmitted by the driver amplifier 404 to a motion control system 414, for example. In some embodiments, the motion control system 414 may be, for example, a programmed computer, a programmed processor, a gate array, a logic circuit, an embedded real time processor, a programmable logic controller (PLC) or the like. In some embodiments, the motion control system 414 may further transmit the information from the encoder and intensity signals 406, 412 to a system controller 416 (e.g., a programmed computer, a programmed processor, a gate array, a logic circuit, an embedded real time processor, etc.). The information may be transmitted via an Ethernet, an intranet, wirelessly or the like. Other suitable transmission means may be used. The system controller 416 may include an algorithm adapted to determine the notch center 306, as described further below. In some embodiments, the motion control system 414 may include an algorithm adapted to determine the notch center 306.

In operation, the motion control system 414 may command the driver 402 to rotate the vacuum chuck, and therefore the substrate 100, as the light source 408 transmits a light beam at the substrate edge 104. Any suitable rotational degree and speed may be used. The sensor 410 may be configured to detect a pre-set threshold, or a particular intensity change in the detected light beam. As the substrate notch 116 rotates in the path of the light beam from the light source 408, the light beam may pass through the substrate notch 116. The change in light intensity from when the substrate edge 104 is in the light beam path to when the substrate notch 116 is in the light beam path may cross the pre-set threshold of the sensor 410 and trigger the sensor 410 to generate the intensity signal 412. The sensor 410 may then send, via the sensor amplifier 411, the intensity signal 412 to the driver amplifier 404. The driver amplifier 404 may in turn send the light intensity signal information and substrate position information to the motion control system 414. The motion control system 414 alone or with the system controller 416 may determine a rough location of the notch 116 based on the substrate position at which the change in light beam intensity was detected. For example, the motion control system 414 may communicate with the system controller 416 to determine a rough location of the first node 302 (FIG. 3) of the notch 116.

To better locate, or determine a fine location of, the notch center 206, the system controller 416 may send a signal to the driver 402 via the motion control system 414 and driver amplifier 404 to rotate the substrate 100 back before the first node 302 or starting point of the notch 116. The substrate 100 may then be rotated in its original rotation direction at a slower speed to determine a more accurate or “fine” location of the first node 302 of notch 116. The rough and fine locations of the second node 304 may be determined in a similar fashion. In some embodiments, the rough locations of the first and second nodes 302, 304 may be determined during the same substrate rotation, and then the fine locations of the first and second nodes 302, 304 may be determined thereafter during a slower substrate rotation of the notch 116 past the light beam path. In some embodiments, the rough location of the notch center 306 may be determined by a large spike in light intensity compared to the light intensity at the rough first and second node 302, 304 locations.

Once the “fine” locations of the first and second nodes 302, 304 have been determined, the system controller 416 may apply an algorithm to the first and second node 302, 304 position information to determine the fine location of the notch center 306 (e.g., ½ the distance between the first and second node locations). The system controller 416 may then send a signal to the driver 402 (via the motion controller 414 and driver amplifier 404) to cause the driver 402 to rotate the substrate 100 such that the substrate 100 may be aligned with respect to the notch center 306.

The use of the present invention may provide highly accurate center notch detection methods and apparatus. Additionally, because the methods and apparatus use sensors and illumination intensity, center notch detection may take place very quickly (e.g., in less than 5 seconds in some embodiments). The use of illumination intensity as an indicator of a notch center location may be insensitive to variations in the size of the substrate, as well as variations in the size of the notch. Also, the present invention methods and apparatus may be insensitive to any eccentricities in the substrate 100 itself in terms of detecting a notch center.

In some embodiments, the polishing system 200 shown in FIG. 2, is a wet environment, as fluids may be used to wash away accumulated particles and aid in the polishing process. Since the present invention detects the notch center 306 using illumination intensity, the present invention may be compatible with such wet environments.

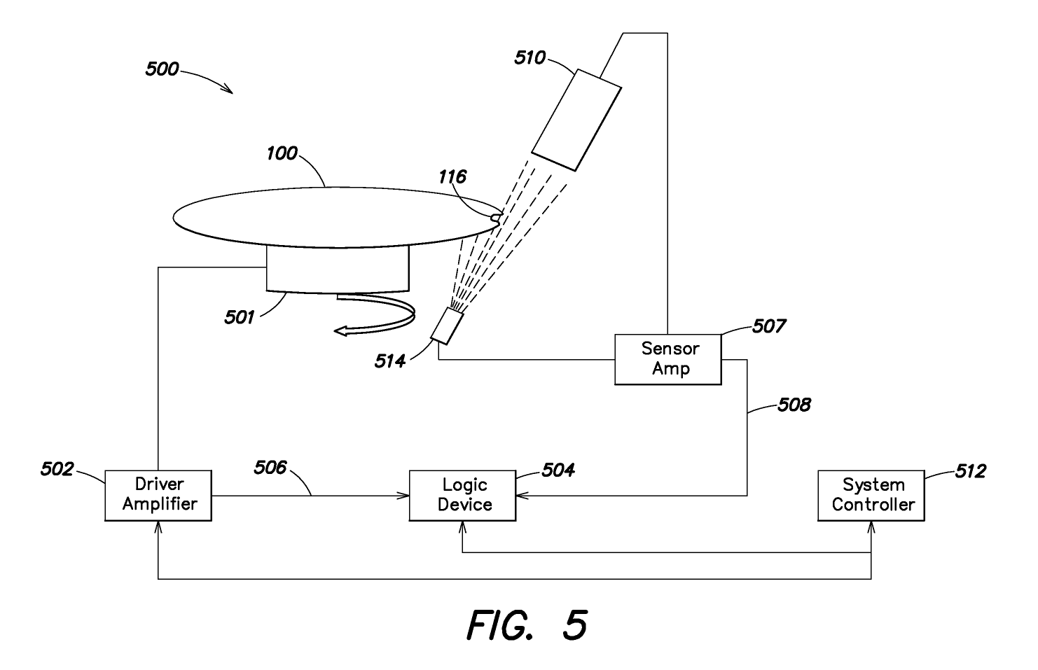

Turning to FIG. 5, an exemplary apparatus 500 for finding the notch center 306 in the substrate edge 104 is depicted according to an alternative embodiment of the present invention. As described above, the substrate 100 may be held and rotated by a vacuum chuck coupled to a driver 501. The apparatus 500 may further include a logic device 504 or controller (e.g., a programmed computer, a programmed processor, a gate array, a logic circuit, an embedded real time processor, etc.). In some embodiments, the logic device 504 may be a programmable logic controller (PLC). Other suitable controllers may be used. The logic device 504 may receive an encoder count signal 506 from a driver amplifier 502 and an intensity signal 508 from a light sensor 510. In some embodiments the intensity signal 508 may be amplified by a sensor amplifier 507, for example. The logic device 504 may also be in communication with a system controller 512, such as a Reflexion® controller provided by Applied Materials of Santa Clara, Calif. The communication between the logic device 504 and the system controller 512 may be bi-directional. Additionally, the system controller 512 may have bi-directional communication with the driver amplifier 502.

The motor encoder count may be synchronized between the logic device 504 and the system controller 512; and the logic device 504 may command the driver 501 to rotate the substrate 100. As in other embodiments, a light source 514 may shine a light beam at the rotating substrate edge 104 of the substrate 100. The light sensor(s) 510 may sense the intensity of the light beam received from the light source 514 and send the intensity signal 508 indicating the intensity, or that the intensity is above or below a certain threshold, to the logic device 504. In some embodiments, the sensor 510 may also include a light source adapted to emit light.

Similarly to the embodiment described above, as the substrate edge 104 passes through the light beam emitted by the light source 514, the light sensor 510 may sense a fairly constant light intensity and send the signal 508 indicating this intensity to the logic device 504. However, when the substrate notch 116 passes through the light beam emitted by the light source 514, the intensity of the illumination detected by the sensor 510 may increase because the substrate notch 116 blocks less of the light beam. This higher light intensity is reflected in the signal 508 sent to the logic device 504. Using the motor encoder count, obtained from the motor encoder count signal 506, the logic device 504 may determine the rough location of the notch 116. In an alternative embodiment, the system controller 512 may receive the higher light intensity information and determine the rough location of the notch 116. The logic device 504 also may adaptively calculate a notch detect threshold based on the light intensity change observed during rough notch location detection. For example, the notch detect threshold may be the particular sensor light intensity at which the notch is detected. Alternatively, a particular notch detect threshold may be pre-set.

Then, to better locate the center of the notch, the logic device 504 may command the driver 501 to rotate the substrate 100 back before the starting point of the notch 116 and then slowly scan the notch 116 past the light beam path to more accurately detect the notch, and/or its edges, nodes and/or center. As above, the logic device 504 (or system controller 512, in some embodiments) may be adapted to determine the rough location of the notch center 306, as well as the location of the first and second nodes 302, 304. After the rough location of the notch center 306 and the fine location of the first and second nodes 302, 304 is determined, the logic device 504 may apply an algorithm to the nodal information to determine the fine location of the notch center 306. The logic device 504 or system controller 512 may then command the driver 501 to rotate the substrate 100 such that the substrate 100 is aligned with respect to the notch center 306.

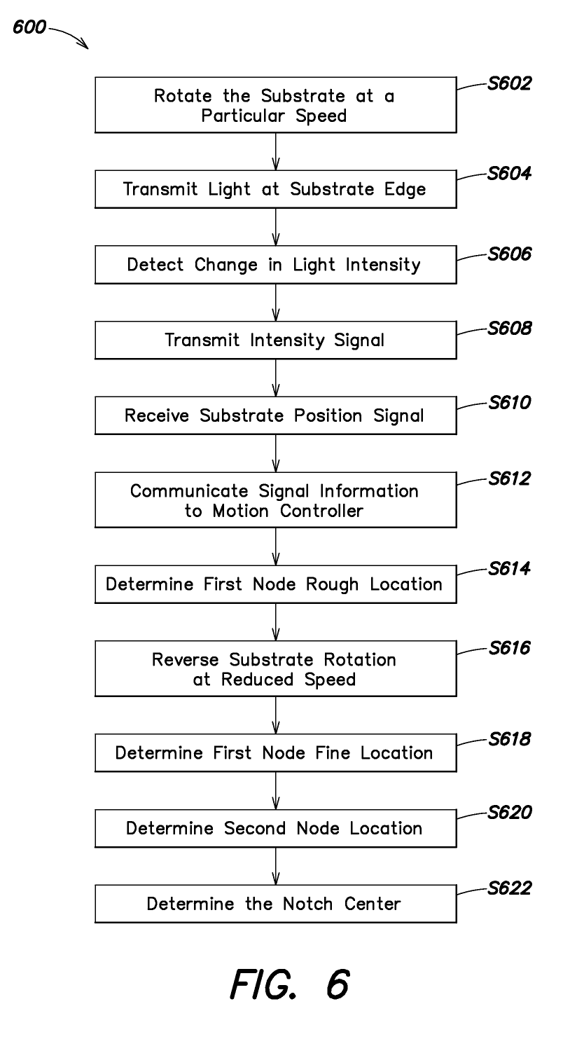

Turning to FIG. 6, a first exemplary method 600 describing an application of the present invention is provided. In step S602, a motion controller commands a driver to rotate a substrate at a particular speed. In some embodiments, the substrate is rotated about 360-365° at about 60 rotations per minute to ensure that the entire notch of the substrate is scanned. Other amounts of rotation and/or rotation rates may be used. In step S604, a light source transmits a light beam at a substrate edge, as the substrate is rotated. As described above, a sensor may be positioned to detect a change in light intensity of the light beam as the notch of the substrate rotates through the path of the light beam (step S606). In some embodiments, the change in light intensity detected by the sensor may be registered when it crosses a pre-set intensity threshold value. In step S608, the sensor transmits an intensity signal to a driver amplifier. The driver amplifier may also receive a position signal from the driver which rotates the substrate (step S610). The position signal may be indicative of the substrate position. The substrate position and changed sensor state information may be communicated to the motion controller in step S612. The motion controller may communicate with the system controller in step S614 to determine a rough location of the first node of the notch based on the position and/or intensity signal information. The rough location of the notch center, and in some embodiments, the second node, may also be found in the same rotation in which the rough location of the first node is determined. Then in step S616, the system controller may command the driver, via the motion controller and driver amplifier, to reverse the rotation of the substrate at a reduced speed to the position right before the first node. In some embodiments, a reduced speed of about 6 rotations per minute may be used. Other rotation rates may be employed. In some embodiments, the substrate may be rotated in the reverse direction in increments. The reverse substrate rotation may allow the first node position to be fine tuned in step S618. The first node may be found again as described by rotating the notch of the substrate through the light beam, but using a slower substrate rotation rate to obtain a more precise location. The second node may be found in a similar fashion in step S620. In step S622, the system controller may apply an algorithm to the first and second node position information to determine the notch center (e.g., node center may be about ½ the distance between the first and second nodes).

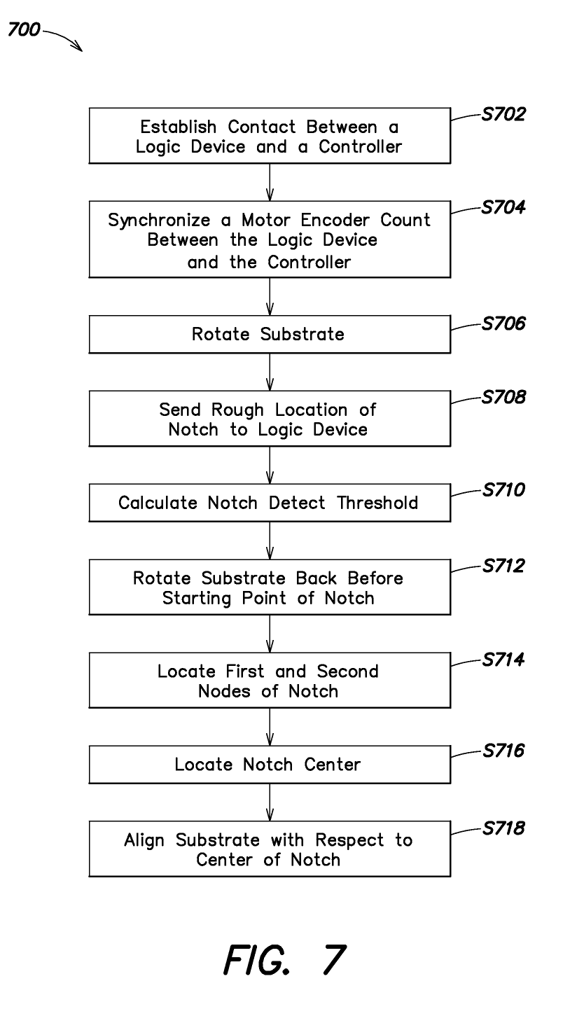

Turning to FIG. 7, a second exemplary method 700 describing an application of the present invention is provided. In step S702, communication between a logic device and a system controller is established. Then in step S704, a motor encoder count is synchronized between the logic device and the system controller. The logic device (or PLC) commands the driver to rotate the substrate (e.g., 365 degrees at 60 rpm in some embodiments) in step S706 while a light beam is transmitted toward the edge of the substrate. The logic device then sends the rough location of the notch back to the system controller in step S708 (e.g., a location at which an intensity change in the light beam is observed due to the notch). In step S710, the logic device adaptively calculates the notch detect threshold (e.g., based on the change in intensity detected when the notch is initially located). Then the logic device commands the driver to rotate the substrate back before a first node position of the notch in step S712. In some embodiments, this may be about two degrees of rotation and performed at a reduced speed of about 6 rpm. Other degrees and speeds may be used. In step S714, the PLC finds the fine location of the first and second nodes of the notch (e.g., by rotating the substrate back through the light beam at a slower speed to detect light intensity changes caused by the notch). Then based on the location of the first and second nodes, the logic device finds the location of the notch center in step S716. In step S718, the logic device or system controller commands the driver to align the substrate with respect to the center of the notch.

It should be understood that the notch center locator apparatus and methods described herein may be employed in apparatuses other than those adapted for locating the center of a notch in substrates. Further, as will be apparent to those of ordinary skill in the art, the apparatus described herein may be employed to locate the center of a notch of a substrate supported in any orientation (e.g., horizontal, vertical, diagonal, etc).

Further, it should be understood that although only examples of determining the location of the center of a notch for a round substrate are disclosed, the present invention could be modified to locate the center of a notch in substrates having other shapes (e.g., a glass or polymer plates for flat panel displays). Further, although processing of a single substrate by the apparatus is shown above, in some embodiments, the apparatus may process a plurality of substrates concurrently.

The foregoing description discloses only exemplary embodiments of the invention. Modifications of the above disclosed apparatus and methods which fall within the scope of the invention will be readily apparent to those of ordinary skill in the art. For instance, an amount of a light beam reflected off of an edge of a substrate may be similarly employed to determine a position and/or center of a notch in the substrate (e.g., as less light will be detected when the light beam strikes the notch of the substrate). Any suitable light beam of any suitable wavelength may be used. Accordingly, while the present invention has been disclosed in connection with exemplary embodiments thereof, it should be understood that other embodiments may fall within the spirit and scope of the invention, as defined by the following claims.

The invention claimed is:

1. A method for locating a center of a notch in a substrate comprising:
rotating a substrate;
illuminating an edge of the substrate with a light beam as the substrate rotates;
detecting a change in light intensity of the light beam as the substrate rotates;
determining a rough location of a notch in the edge of the substrate based on a position of the substrate when the change in light intensity of the light beam is detected; and
reversing a rotational direction of the substrate to determine a fine location of the notch in the edge of the substrate.

2. The method of claim 1 further comprising determining a center of the notch.

3. The method of claim 1 wherein determining a rough location includes determining when the change in light intensity exceeds a pre-set intensity threshold.

4. The method of claim 1 wherein determining a rough location of the notch further comprises determining a rough location of a first node of the notch.

5. The method of claim 1 wherein determining a fine location of the notch further comprises determining a fine location of a first node of the notch.

6. The method of claim 5 wherein determining a fine location of a first node of the notch comprises rotating the substrate at a reduced speed to determine the fine location of the first node of the notch.

7. The method of claim 4 further comprising:
determining a fine location of a second node of the notch; and
determining a center of the notch based on the fine locations of the first and second nodes.

8. The method of claim 7 further comprising aligning the substrate with respect to the center of the notch.

9. An apparatus for detecting a notch in an edge of a substrate, the apparatus comprising:
a substrate support adapted to support and rotate a substrate;
a light source adapted to emit a light beam at an edge of the substrate as the substrate is rotated by the substrate support;
a sensor adapted to detect a change in light intensity of the light beam as the substrate rotates; and
at least one controller adapted to:
determine a rough location of a notch in the edge of the substrate based on a position of the substrate when the change in light intensity of the light beam is detected by the sensor; and
reverse a rotational direction of the substrate to determine a fine location of the notch in the edge of the substrate.

10. The apparatus of claim 9 wherein the at least one controller is adapted to determine a center of the notch based on the fine location of the notch.

11. The apparatus of claim 9 wherein the sensor is a digital or analog sensor.

12. The apparatus of claim 9 wherein the at least one controller is adapted to cause the substrate support to rotate the substrate at a first speed to determine the rough location of the notch.

13. The apparatus of claim 12 wherein the at least one controller is adapted to cause the substrate support to rotate at a reduced, second speed to determine the fine location of the notch.

14. The apparatus of claim 9 wherein the at least one controller is adapted to cause the substrate support to rotate:
in a first direction at a first speed to determine the rough location of the notch;
in a second opposite direction past the rough location of the notch; and
back in the first direction at a reduced, second speed to determine the fine location of the notch.

15. The apparatus of claim 9 wherein the at least one controller is further adapted to determine first and second nodal positions of the notch.

16. The apparatus of claim 15 wherein the at least one controller is adapted to determine a center of the notch based on the first and second nodal positions.
